(19) United States
(12) Patent Application Publication
(10) Pub. No.: US 2012/0261079 A1
(43) Pub. Date: Oct. 18, 2012

(54) METHOD OF CONTROLLING A MOTORIZED WINDOW TREATMENT TO SAVE ENERGY

(76) Inventors: Samuel F. Chambers, Gwynedd Valley, PA (US); David A. Kirby, Zionsville, PA (US); Justin J. Mierta, Allentown, PA (US); Joel S. Spira, Coopersburg, PA (US)

(21) Appl. No.: 13/415,512

(22) Filed: Mar. 8, 2012

Related U.S. Application Data
(60) Provisional application No. 61/451,960, filed on Mar. 11, 2011.
(60) Provisional application No. 61/530,799, filed on Sep. 2, 2011.
(60) Provisional application No. 61/547,319, filed on Oct. 14, 2011.

(51) Int. Cl. E05F 15/20; E05F 15/10

(52) U.S. Cl. 160/6; 160/7; 160/1

(57) ABSTRACT

A motorized window treatment to automatically control the position of a covering material in front of a window to save energy. The motorized window treatment has an eco-mode whereby to at least one climate characteristic is measured by a sensor to save energy by decreasing the load on a heating and/or cooling system of the room in which the motorized window treatment is installed. The motorized window treatment opens the covering material on sunny winter days to allow energy from sunlight to be stored in the mass of the room, and closes the covering material at night to insulate the room and allow the energy from the sunlight stored in the mass of the room to heat the room and reduce the load on the heating and cooling system at night.

### CROSS REFERENCES TO RELATED APPLICATIONS

This application is a non-provisional application of commonly-assigned U.S. Provisional Application No. 61/451,960, filed Mar. 11, 2011; U.S. Provisional Application No. 61/530,799, filed Sep. 2, 2011; and U.S. Provisional Application No. 61/547,319, filed Oct. 14, 2011, all entitled MOTORIZED WINDOW TREATMENT, the entire disclosures of which are hereby incorporated by reference.

### FIELD OF THE INVENTION

The present invention relates to a motorized window treatment, and more specifically, to a low-cost, battery-powered motorized window treatment that operates in an eco-mode (i.e., an energy-savings mode) for saving energy by reducing the load on a heating and/or cooling system.

### DESCRIPTION OF THE RELATED ART

Reducing the total cost of energy is an important goal for many consumers. For example, it is particularly desirable to reduce the amount of energy used to heat and cool their homes or buildings. There is much heat transfer in and out of a typical window in a building. Heat may be lost through the window during the winter, and gained through the window during the summer (e.g., due to solar heating from sunlight).

Some prior art load control systems have attempted to reduce this heat transfer to thus reduce the load on a heating and/or cooling system of the building by controlling the position of a covering material of a motorized window treatment located in front of the window. In addition, some prior art load control systems have tried to take advantage of the heat transfer to further reduce the load on the heating and/or cooling system by opening or closing the covering material of the motorized window treatment. Examples of such prior art load control systems are described in U.S. Pat. No. 6,064,949, issued May 16, 2000, entitled METHOD AND APPARATUS FOR CONTROLLING A SCREEING DEVICE BASED ON MORE THAN ONE SET OF FACTORS, and U.S. Pat. No. 7,389,806, issued Jun. 24, 2008, entitled MOTORIZED WINDOW SHADE SYSTEM. However, these load control systems have either required a central controller or a direct electrical connection (e.g., a control link) between the motorized window treatment and the heating and/or cooling system.

Thus, there is a need for a self-contained motorized window treatment that is able to automatically control the position of the covering material of the motorized window treatment in response to climate conditions to thus save energy by reducing the load on the heating and/or cooling system without the need for a central controller or an electrical connection to another control device or system. In addition, there is a need for a load control system that is able to more effectively control the motorized window treatment and the heating and/or cooling system to take advantage of the heat transfer through the window to thus reduce the load on the heating and/or cooling system.

### SUMMARY OF THE INVENTION

The present invention provides a low-cost, quiet, battery-powered motorized window treatment that is able to automatically control the position of a covering material hanging in front of a window in order to save energy. The motorized window treatment is operable to automatically control the covering material according to an eco-mode (i.e., an energy-saving mode) in response to at least one climate characteristic measured by a sensor of the motorized window treatment to save energy by decreasing the load on a heating and/or cooling system of the room in which the motorized window treatment is installed. The motorized window treatment may be configured to operate in the eco-mode to save energy without requiring any advanced programming procedures or computing devices. For example, the motorized window treatment may be operable to open the covering material on sunny winter days to allow the energy from the sunlight stores in the mass of the room, and then close the covering material at night to insulate the room and allow the energy from the sunlight stored in the mass of the room to heat the room to thus reduce the load on the heating and cool system at night.

According to an embodiment of the present invention, a motor drive unit for a motorized window treatment is operable to control a covering material adapted to be mounted in a room next to a window according to an eco-mode of operation. The covering material is adapted to be controlled between a fully-open position and a fully-closed position to control the amount of the window covered by the covering material. The motor drive unit comprises a window-side temperature sensor adapted to measure an external temperature representative of the temperature outside the window, and a controller coupled to the window-side temperature sensor for determining the external temperature representative of the temperature outside the window. The controller is operable to compare the external temperature to an internal temperature to determine whether heat is flowing in or out of the room though the window. The interior temperature is representative of the temperature in the room in which the window treatment is installed. The controller is further operable to determine a present time of the year in response to a measured characteristic. The controller operates in an eco-mode to automatically control the amount of the window covered by the covering material in response to the present time of the year and whether heat is flowing in or out of the room though the window to save energy.

According to another embodiment of the present invention, a load control system for a building comprising a window and a heating and/or cooling system comprises a temperature control device adapted to be coupled to the heating and/or cooling system for controlling a present temperature in the building towards a setpoint temperature, and a motorized window treatment for adjusting the position of a covering material between a fully-open position and a fully-closed position to control the amount of a window covered by the covering material. The motorized window treatment comprises a motor drive unit operable to determine an external temperature representative of the temperature outside the window. The motor drive unit is operable to compare the external temperature to an internal temperature to determine whether heat is flowing in or out of the room though the window. The interior temperature is representative of the temperature in the room in which the window treatment is installed. The motor drive unit is further operable to determine a present time of the year in response to a measured characteristic. The controller operates in an eco-mode to automatically control the amount of the window covered by the covering material in response to the present time of the day and year and whether heat is flowing in or out of the room though the window, so as to reduce the power consumption of the heating and/or cooling system.

In addition, a method of controlling a motorized window treatment having a covering material adapted to be mounted in a room next to a window is also described herein. The covering material is adapted to be controlled between a fully-open position and a fully-closed position to control the amount of the window covered by the covering material. The method comprises: (1) measuring an external temperature representative of the temperature outside the window; (2) comparing the external temperature to an internal temperature to determine whether heat is flowing in or out of the room though the window, the interior temperature representative of the temperature in the room in which the window treatment is installed; (3) determining a present time of the year in response to a measured characteristic; and (4) operating in an eco-mode to automatically control the amount of the window covered by the covering material in response to the present time of the year and whether heat is flowing in or out of the room though the window to save energy.

Other features and advantages of the present invention will become apparent from the following description of the invention that refers to the accompanying drawings.

### BRIEF DESCRIPTION OF THE DRAWINGS

The invention will now be described in greater detail in the following detailed description with reference to the drawings in which:

FIG. 1 is a perspective view of a motorized window treatment system having a battery-powered motorized window treatment and a remote control according to a first embodiment of the present invention;

FIG. 2 is a perspective view of the battery-powered motorized window treatment of FIG. 1 in a full-opened position;

FIG. 3 is a right side view of the battery-powered motorized window treatment of FIG. 1;

FIG. 4 is a front view of the battery-powered motorized window treatment of FIG. 1;

FIG. 5 is a simplified block diagram of a motor drive unit of the battery-powered motorized window treatment of FIG. 1;

FIG. 6 is a simplified flowchart of a command procedure executed periodically by a controller of the motor drive unit of FIG. 5;

FIG. 7 is a simplified flowchart of an eco-mode procedure executed periodically by the controller of the motor drive unit of FIG. 5;

FIG. 8 is a simplified flowchart of an alternative eco-mode procedure executed periodically by the controller of the motor drive unit of FIG. 5;

FIG. 9 is a simplified diagram of a radio-frequency load control system including multiple motorized window treatments, such as cellular shades and Venetian blinds, according to a second embodiment of the present invention;

FIG. 10 is a simplified diagram of a room including motorized Venetian blinds having slats tilted to reflect sunlight onto a ceiling of the room;

FIG. 11 is a simplified diagram of the room of FIG. 10 showing the slats of the motorized Venetian blinds tilted to block sunlight from entering the room; and

FIG. 12 is a simplified flowchart of an eco-mode procedure according to the second embodiment of the present invention.

### DETAILED DESCRIPTION OF THE INVENTION

The foregoing summary, as well as the following detailed description of the preferred embodiments, is better understood when read in conjunction with the appended drawings. For the purposes of illustrating the invention, there is shown in the drawings an embodiment that is presently preferred, in which like numerals represent similar parts throughout the several views of the drawings, it being understood, however, that the invention is not limited to the specific methods and instrumentalities disclosed.

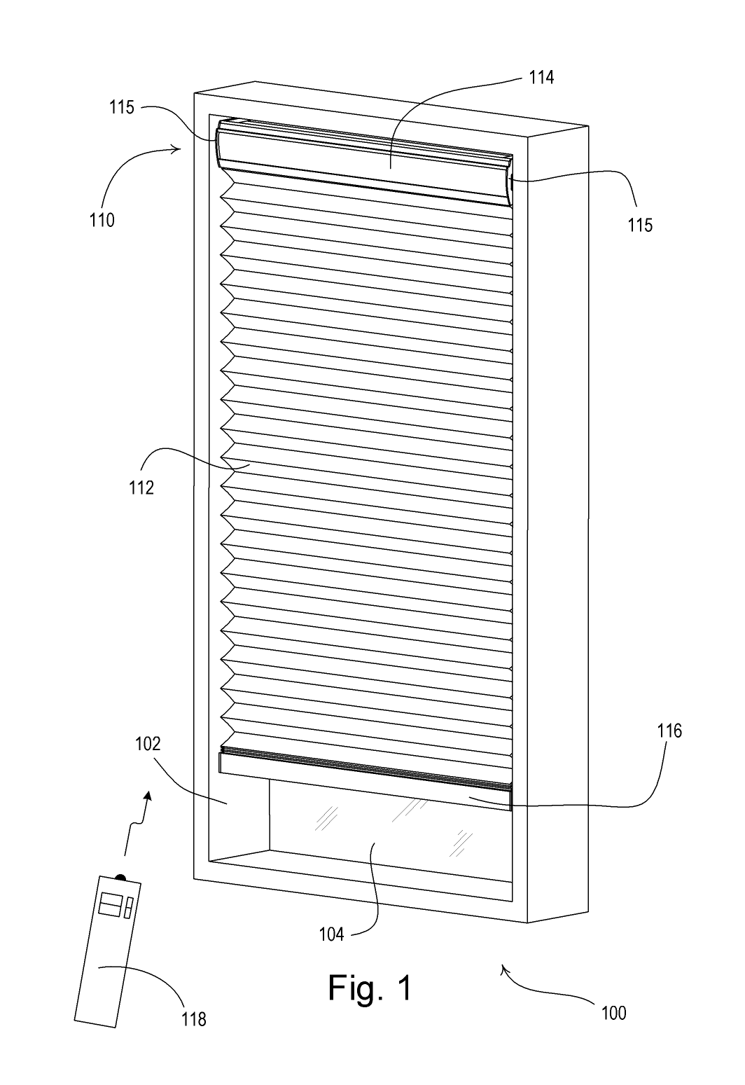

FIG. 1 is a perspective view of a motorized window treatment system 100 having a battery-powered motorized window treatment 110 mounted in an opening 102, for example, in front of a window 104, according to a first embodiment of the present invention. The battery-powered motorized window treatment 110 comprises a covering material, for example, a cellular shade fabric 112 as shown in FIG. 1. The cellular shade fabric 112 has a top end connected to a headrail 114 (that extends between two mounting plates 115) and a bottom end connected to a weighting element 116. The mounting plates 115 may be connected to the sides of the opening 102 as shown in FIG. 1, such that the cellular shade fabric 112 is able to hang in front of the window 104, and may be adjusted between a fully-open position P_{FULLY-OPEN} and a fully-closed position P_{FULLY-CLOSED} to control the amount of daylight entering a room or space. Alternatively, the mounting plates 115 of the battery-powered motorized window treatment 110 could be mounted externally to the opening 102 (e.g., above the opening) with the shade fabric 112 hanging in front of the opening and the window 104. In addition, the battery-powered motorized window treatment 110 could alternatively comprise other types of covering materials, such as, for example, a plurality of horizontally-extending slats (i.e., a Venetian or Persian blind system), pleated blinds, a roller shade fabric, or a Roman shade fabric. According to the first embodiment of the present invention, the motorized window treatment system 100 comprises an infrared (IR) remote control 118 for controlling the operation of the motorized window treatment 110.

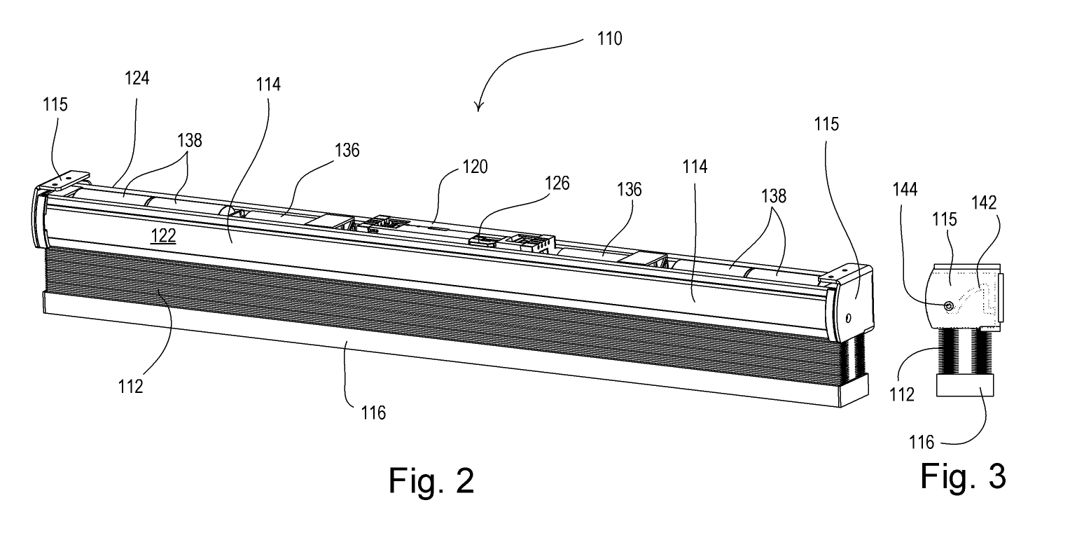

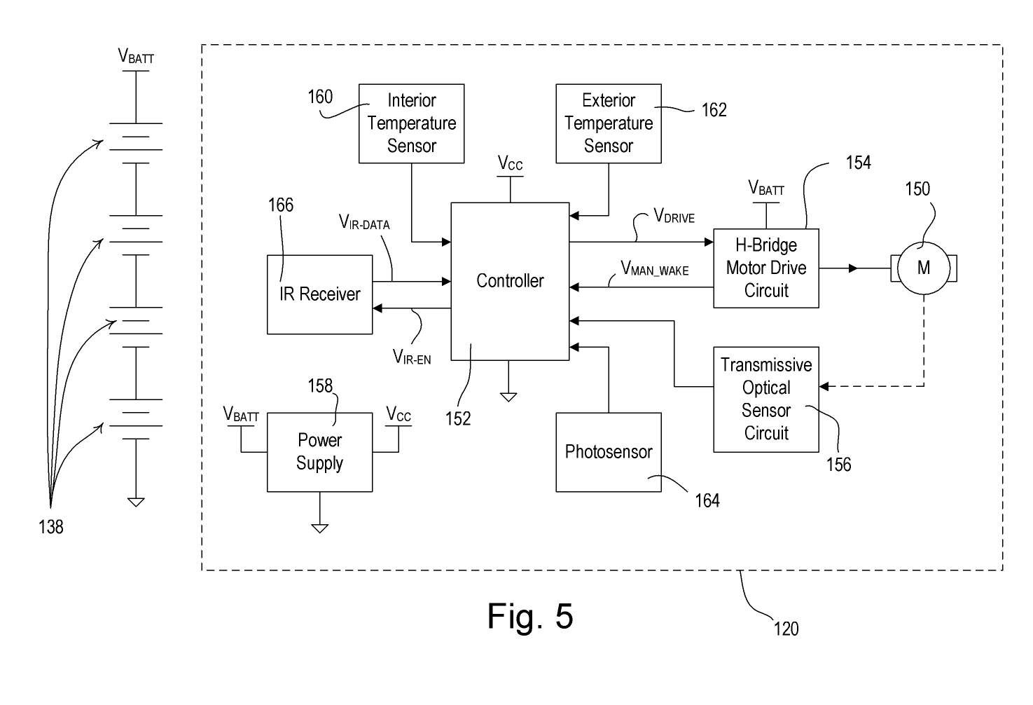

FIG. 2 is a perspective view and FIG. 3 is a right side view of the battery-powered motorized window treatment 110 with the cellular shade fabric 112 in the fully-open position P_{FULLY-OPEN}. The motorized window treatment 110 comprises a motor drive unit 120 for raising and lowering the weighting element 116 and the cellular shade fabric 112 between the fully-open position P_{FULLY-OPEN} and the fully-closed position P_{FULLY-CLOSED}. By controlling the amount of the window 104 covered by the cellular shade fabric 112, the motorized window treatment 110 is able to control the amount of daylight entering the room. The headrail 114 of the motorized window treatment 110 comprises an internal side 122 and an opposite external side 124, which faces the window 104 that the shade fabric 112 is covering. The motor drive unit 120 comprises an actuator 126, which is positioned adjacent the internal side 122 of the headrail 114 may may be actuated when a user is configuring the motorized window treatment 110. The actuator 126 may be made of, for example, a clear material, such that the actuator may operate as a light pipe to conduct illumination from inside the motor drive unit 120 to thus be provide feedback to the user of the motorized window treatment 110. In addition, the actuator 126 may also function as an IR-receiving lens for directing IR signals transmitted by the IR remote control 118 to an IR receiver 166 (FIG. 5) inside the motor drive unit 120. The motor drive unit 120 is operable to determine a target position P_{TARGET} for the weighting element 116 in response to commands included in the IR signals received from the remote control 118 and to subsequently control a present position P_{PRES} of the weighting element to the target position P_{TARGET}. As shown in FIG. 2, a top side 128 of the headrail 114 is open, such that the motor drive unit 120 may be positioned inside the headrail and the actuator 126 may protrude slightly over the internal side 122 of the headrail.

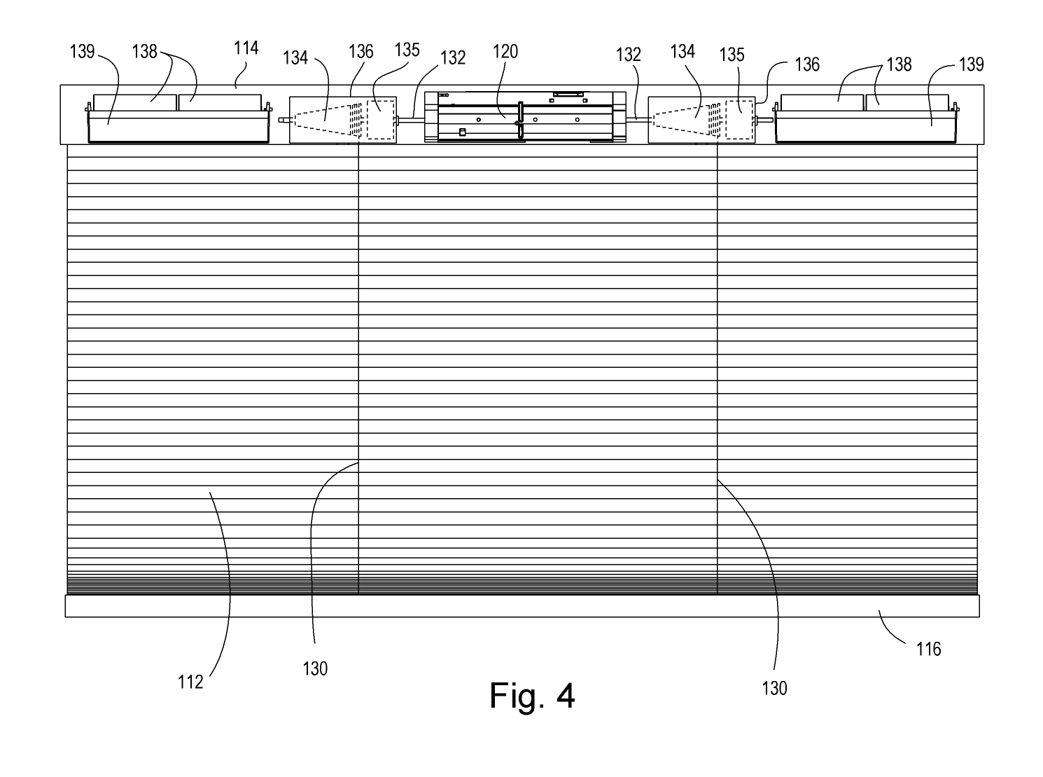

FIG. 4 is a front view of the battery-powered motorized window treatment 110 with a front portion of the headrail 114 removed to show the motor drive unit 120. The motorized window treatment 110 comprises lift cords 130 that extend from the headrail 114 to the weighting element 116 for allowing the motor drive unit 120 to raise and lower the weighting element. The motor drive unit 120 includes an internal motor 150 (FIG. 5) coupled to drive shafts 132 that extend from the motor on each side of the motor and are each coupled to a respective lift cord spool 134. The lift cords 130 are windingly received around the lift cord spools 134 and are fixedly attached to the weighting element 116, such that the motor drive unit 120 is operable to rotate the drive shafts 132 to raise and lower the weighting element. The motorized window treatment 110 further comprises two constant-force spring assist assemblies 135, which are each coupled to the drive shafts 132 adjacent to one of the two lift cord spools 134. Each of the lift cord spools 134 and the adjacent constant-force spring assist assembly 135 are housed in a respective lift cord spool enclosure 136 as shown in FIG. 3. Alternatively, the motor drive unit 120 could be located at either end of the headrail 114 and the motorized window treatment 110 could comprise a single drive shaft that extends along the length of the headrail and is coupled to both of the lift cord spools 134.

The battery-powered motorized window treatment 110 also comprises a plurality of batteries 138 (e.g., four D-cell batteries), which are electrically coupled in series. The seris-combination of the batteries 138 is coupled to the motor drive unit 120 for powering the motor drive unit. The batteries 138 are housed inside the headrail 114 and thus out of view of a user of the motorized window treatment 110. Specifically, the batteries 138 are mounted in two battery holders 139 located inside the headrail 114, such that there are two batteries in each battery holder as shown in FIG. 4. According to the embodiments of the present invention, the batteries 138 provide the motorized window treatment 110 with a practical lifetime (e.g., approximately three years), and are typical “off-the-shelf” batteries that are easy and not expensive to replace. Alternatively, the motor drive unit 120 could comprise more batteries (e.g., six or eight) coupled in series or batteries of a different kind (e.g., AA batteries) coupled in series.

FIG. 5 is a simplified block diagram of the motor drive unit 120 of the battery-powered motorized window treatment 110. The motor drive unit 120 comprises a controller 152 for controlling the operation of the motor 150, which may comprise, for example, a DC motor. The controller 152 may comprise, for example, a microprocessor, a programmable logic device (PLD), a microcontroller, an application specific integrated circuit (ASIC), a field-programmable gate array (FPGA), or any suitable processing device or control circuit. The controller 152 is coupled to an H-bridge motor drive circuit 154 for driving the motor 150 via a set of drive signals V_{DRIVE} to control the weighting element 116 and the cellular shade fabric 112 between the fully-open position P_{FULLY-OPEN} and the fully-closed position P_{FULLY-CLOSED}. The controller 152 is operable to rotate the motor 150 at a constant rotational speed by controlling the H-bridge motor drive circuit 154 to supply a pulse-width modulated (PWM) drive signal having a constant duty cycle to the motor. The controller 152 is able to change the rotational speed of the motor 150 by adjusting the duty cycle of the PWM signal applied to the motor and to change the direction of rotation of the motor by changing the polarity of the PWM drive signal applied to the motor.

The controller 152 receives information regarding the rotational position and direction of rotation of the motor 150 from a rotational position sensor, such as, for example, a transmissive optical sensor circuit 156. The rotational position sensor may also comprise other suitable position sensors, such as, for example, Hall-effect, optical or resistive sensors. The controller 152 is operable to determine a rotational position of the motor 150 in response to the transmissive optical sensor circuit 156, and to use the rotational position of the motor to determine a present position P_{PRES} of the weighting element 116. The controller 152 may comprise an internal non-volatile memory for storage of the present position P_{PRES} of the shade fabric 112, the fully open position P_{FULLY-OPEN}, and the fully closed position P_{FULLY-CLOSED}. Alternatively, the motor drive unit 120 may comprise an external memory coupled to the controller 152 for storage of the present position.

As previously mentioned, the motor drive unit 120 receives power from the series-coupled batteries 138, which provide a battery voltage V_{BATT}. For example, the batteries 138 may comprise D-cell batteries having rated voltages of approximately 1.5 volts, such that the battery voltage V_{BATT} has a magnitude of approximately 6 volts. The H-bridge motor drive circuit 154 receives the battery voltage V_{BATT} for driving the motor 150. The motor drive unit 120 further comprises a power supply 158 (e.g., a linear regulator) that receives the battery voltage V_{BATT} and generates a DC supply voltage V_{CC} (e.g., approximately 3.3 volts) for powering the controller 152 and other low-voltage circuitry of the motor drive unit.

A user of the window treatment system 100 is able to adjust the position of the weighting element 116 and the cellular shade fabric 112 by using the remote control 118 to transmit commands to the motor drive unit 120 via the IR signals. The IR receiver 166 receives the IR signals and provides an IR data control signal V_{IR-DATA} to the controller 152, such that the controller is operable to receive the commands from the remote control 118. The controller 152 is operable to put the IR receiver 166 to sleep (i.e., disable the IR receiver) and to periodically wake the IR receiver up (i.e., enable the IR receiver) via an IR enable control signal V_{IR-EN}, as will be described in greater detail below. An example of an IR control system is described in greater detail in U.S. Pat. No. 6,545,434, issued Apr. 8, 2003, entitled MULTI-SCENE PRESET LIGHTING CONTROLLER, the entire disclosure of which is hereby incorporated by reference. Alternatively, the IR receiver 166 could comprise a radio-frequency (RF) receiver or transceiver for receiving RF signals transmitted by an RF remote control. Examples of RF control systems are described in greater detail in U.S. patent application Ser. No. 12/033,223, filed Feb. 19, 2008, entitled COMMUNICATION PROTOCOL FOR A RADIO-FREQUENCY LOAD CONTROL SYSTEM, and U.S. patent application Ser. No. 13/415,084 filed Mar. 8, 2012, entitled MOTORIZED WINDOW TREATMENT, the entire disclosures of which are hereby incorporated by reference.

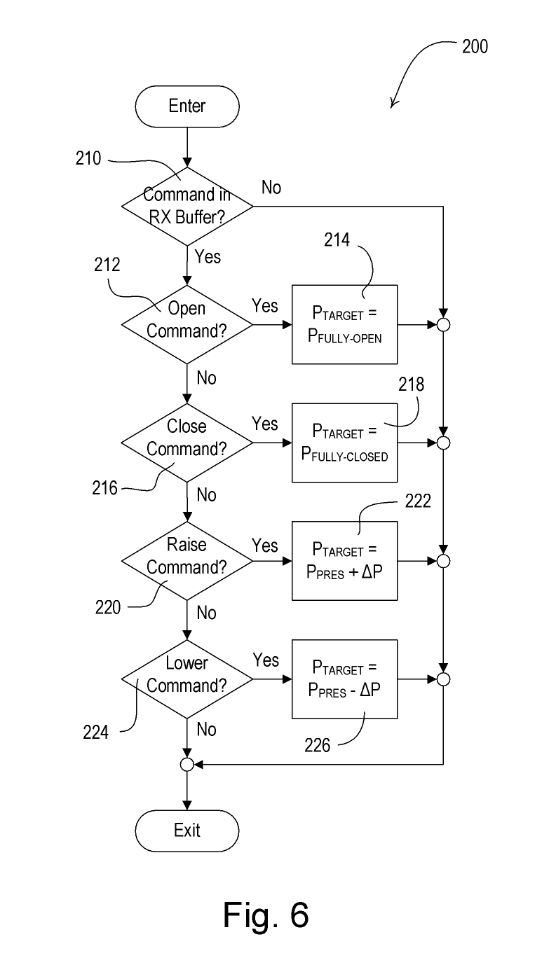

FIG. 6 is a simplified flowchart of a command procedure 200 executed periodically by the controller 152. The controller 152 stores commands received from the IR remote control 118 in a receive (RX) buffer. If there is not a command in the RX buffer at step 210, the command procedure 200 simply exits. However, if there is an open command in the RX buffer at step 212, the controller 152 sets the target position P_{TARGET} equal to the fully-open position P_{FULLY-OPEN} at step 214, before the command procedure 200 exits. If the received command is a close command at step 216, the controller 152 sets the target position P_{TARGET} equal to the fully-closed position P_{FULLY-CLOSED} at step 218 and the command procedure 200 exits. If the received command is a raise command at step 220 or a lower command at step 224, the controller 152 respectively increases the target position P_{TARGET} by a predetermined increment AP at step 222 or decreases the target position P_{TARGET} by the predetermined increment AP at step 226, before the command procedure 200 exits.

Referring back to FIG. 5, the motor drive unit 120 comprises an internal temperature sensor 160 that is located adjacent the internal side 122 of the headrail 114 (i.e., a room-side temperature sensor), and an external temperature sensor 162 that is located adjacent the external side 124 of the headrail (i.e., a window-side temperature sensor). The room-side temperature sensor 160 is operable to measure an interior temperature T_{INT} inside the room in which the motorized window treatment 110 is installed, while the external temperature sensor 162 is operable to measure an exterior temperature T_{EXT} between the headrail 114 and the window 104. The motor drive unit 120 further comprises a photosensor 164, which is located adjacent the external side 124 of the headrail 114, and is directed to measure the amount of sunlight that may be shining on the window 104. Alternatively, the exterior (window-side) temperature sensor 162 may be implemented as a sensor label (external to the headrail 114 of the battery powered motorized window treatment 110) that is operable to be affixed to an inside surface of a window. The sensor label may be coupled to the motor drive unit 120 through low voltage wiring (not shown).

The controller 152 receives inputs from the internal temperature sensor 160, the external temperature sensor 162, and the photosensor 164. According to the first embodiment of the present invention, the controller 152 may operate in an eco-mode (i.e., an energy-savings mode) to control the position of the weighting element 116 and the cellular shade fabric 112 in response to the internal temperature sensor 160, the external temperature sensor 162, and the photosensor 164, so as to provide energy savings. When operating in the eco-mode, the controller 152 adjusts the amount of the window 104 covered by the cellular shade fabric 112 to attempt to save energy, for example, by reducing the amount of electrical energy consumed by other control systems in the building in which the motorized window treatment 110 is installed. For example, the controller 152 may adjust the present position P_{PRES} of the weighting element 116 to control the amount of daylight entering the room in which the motorized window treatment 110 is installed, such that lighting loads in the room may be turned off or dimmed to thus save energy. In addition, the controller 152 may adjust the present position P_{PRES} of the weighting element 116 to control the heat flow through the window 104 in order to lighten the load on a heating and/or cooling system, e.g., a heating, air-conditioning, and ventilation (HVAC) system, in the building in which the motorized window treatment 110 is installed.

The controller 152 is operable to determine the present time of the day and year in response to a measured characteristic from the internal temperature sensor 160, the external temperature sensor 162, and the photosensor 164. For example, the measured characteristic may be the light intensity outside the window as measured by the photosensor 164. The controller 152 may determine that the present time of day is nighttime if the light intensity measured by the photosensor 164 is less than a nighttime intensity threshold, which may be predetermined and stored in the memory of the controller 152. Alternatively, the controller 152 may be operable to modify the nighttime intensity threshold by measuring the minimum light intensities measured by the photosensor 164 over a period of time, and updating the nighttime intensity threshold based upon these measurements. The controller 152 may be operable to determine the present time of the year by determining the length of daylight (e.g., the time each day that the light intensity measured by the photosensor 164 exceeds the nighttime intensity threshold) and to compare the determined length of daylight to data representing typical day lengths, e.g., data from the American Society of Heating, Refrigerating and Air Conditioning Engineers (ASHRAE).

Alternatively, the motor drive unit 120 may not comprise the photosensor 164 and the measured characteristic could comprise the exterior temperature T_{EXT} measured by the external temperature sensor 162. The controller 152 could determine the transition between daytime and nighttime hours by analyzing the measured exterior interior temperature T_{EXT} to thus establish thresholds for determining the present time of the day. The controller 152 could then determine the present time of the year by comparing the determined length of the daytime hours to data representing typical day lengths, e.g., ASHRAE data.

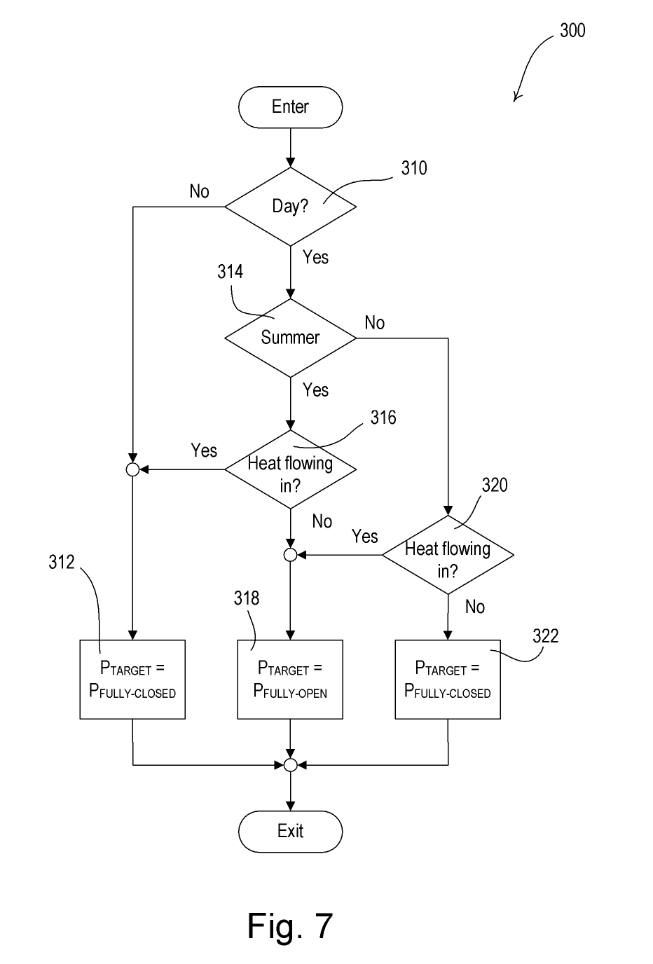

FIG. 7 is a simplified flowchart of an eco-mode procedure 300 executed periodically by the controller 152 when the controller is operating in the eco-mode. For example, the controller 152 may be operable to enter the eco-mode in response to command received from the IR remote control 118. When executing the eco-mode procedure 300, the controller 152 first determines if the present time of day is daytime or nighttime at step 610 using the photosensor 164, which faces the window 104 in front of which the motorized window treatment 110 is installed. If the controller 152 determines that the present time of day is night at step 310, the controller sets the target position P_{TARGET} equal to the fully-closed position P_{FULLY-CLOSED} at step 312 and the eco-mode procedure 600 exits. If the controller 152 determines that the present time is daytime at step 610, the controller 512 then determines the present time of year at step 614, for example, by determining if the present time of year is summer or winter.

The controller 152 is further able to determine at step 316 if heat is flowing through the window 104 into the room or out of the room by comparing the exterior temperature T_{EXT} measured by the external temperature sensor 162 to the interior temperature T_{INT} measured by the room-side temperature sensor 160. For example, if the exterior temperature T_{EXT} is greater than the interior temperature T_{INT}, the controller 152 may determine that heat is flowing into the room through the window 104. If the exterior temperature T_{EXT} is less than the interior temperature T_{INT}, the controller 152 may determine that heat is flowing out of the window 104.

If the present time of year is summer at step 314 and heat is flowing into the room through the window 104 at step 316, the controller 152 sets the target position P_{TARGET} equal to the fully-closed position P_{FULLY-CLOSED} at step 312 to close the motorized window treatment 110 and prevent the sunlight from heating the room. If the present time of year is summer at step 314 and heat is flowing out of the window 104 at step 316, the controller 152 sets the target position P_{TARGET} equal to the fully-open position P_{FULLY-OPEN} at step 318 to open the motorized window treatment 110 to take advantage of the daylight, such that the lighting loads in the room may be turned off or dimmed. If the present time of year is winter at step 314 and heat is flowing into the room through the window 104 at step 320, the controller 152 opens the motorized window treatment 110 at step 318 to allow the sunlight to heat the room. If the present time of year is winter at step 614 and heat is flowing out of the window 104 at step 320, the controller 152 closes the motorized window treatment 110 at step 322 to insulate the room and prevent heat from flowing out the room.

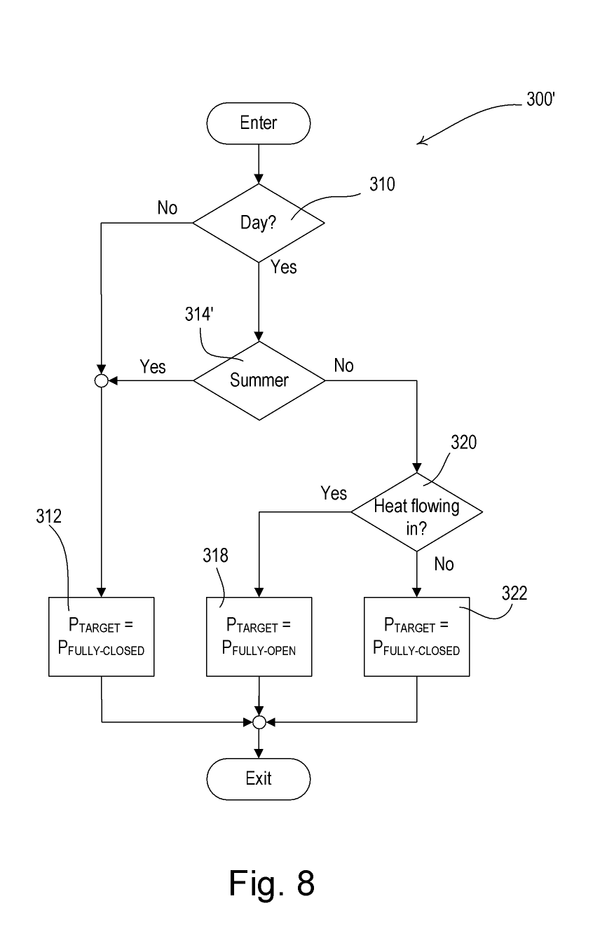

FIG. 8 is a simplified flowchart of an eco-mode procedure 300′ according to an alternate embodiment executed periodically by the controller 152 when the controller is operating in the eco-mode. Many of the steps of the eco-mode procedure 300′ are similar to those of eco-mode procedure 300. However, if the controller 152 determines that the present time is daytime at step 310, then the controller determines if the present time of year is summer at step 314′. If the controller 152 determines that the present time of year is summer, then the controller simply sets the target position P_{TARGET} equal to the fully-closed position P_{FULLY-CLOSED} at step 312 to close the motorized window treatment 110 and prevent the sunlight from heating the room, before the eco-mode procedure 300′ exits. Otherwise, the controller 152 executes steps 318-322 as described above with respect to eco-mode procedure 300, before the eco-mode procedure 300′ exits.

Alternatively, the motor drive unit 120 may not comprise the internal temperature sensor 160, but could simply assume that the internal temperature T_{INT} inside the room is a predetermined room temperature (e.g., approximately 22° C.).

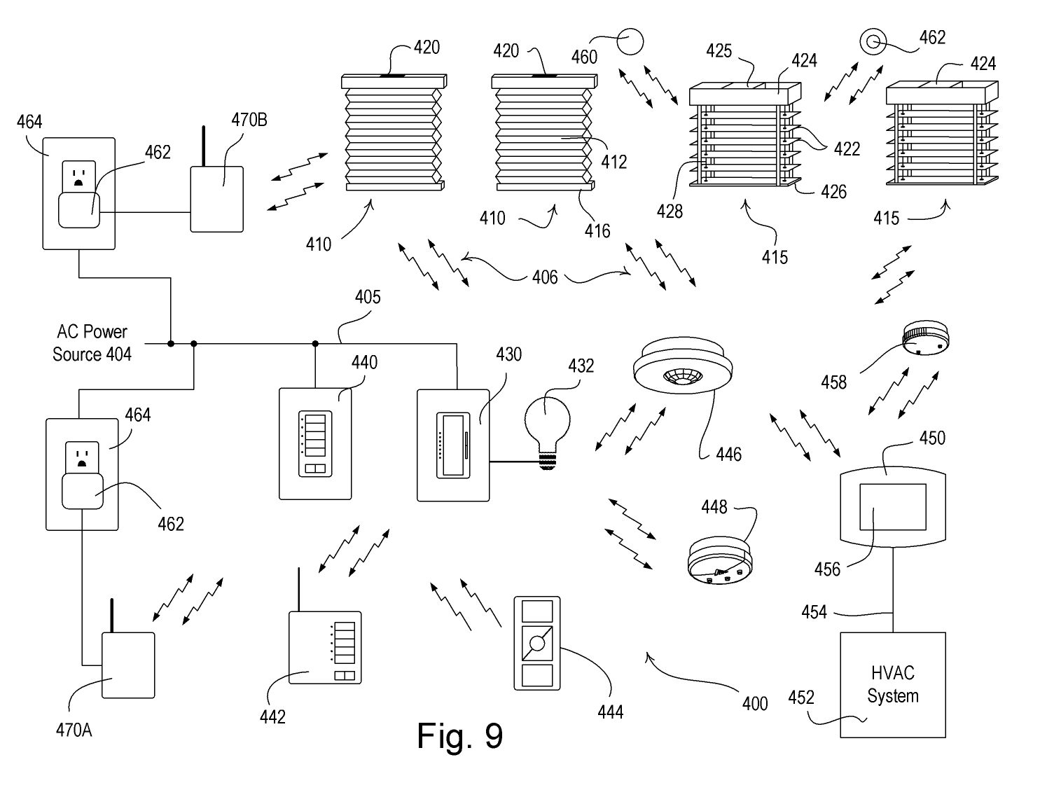

The IR receiver 166 could alternatively comprise a radio-frequency (RF) receiver or transceiver for receiving RF signals transmitted by an RF remote control. FIG. 9 is a simplified diagram of a radio frequency (RF) load control system 400 having multiple battery-powered motorized window treatments, such as, motorized cellular shades 410 and motorized Venetian blinds 415, according to a second embodiment of the present invention. The motorized window treatments 410, 415 of the second embodiment each have very similar electrical circuitry as the battery-powered motorized window treatment 110 of the first embodiment (as shown in FIG. 5). However, the motorized window treatments 410, 415 of the second embodiment comprise respective drive units 420, 425 having RF transceivers rather than IR receivers, such that the motorized window treatments are operable to transmit and receive RF signals 406. Alternatively, the drive units 420, 425 could comprise RF receivers for simply receiving RF signals. Examples of RF control systems are described in greater detail in U.S. patent application Ser. No. 12/033,223, filed Feb. 19, 2008, entitled COMMUNICATION PROTOCOL FOR A RADIO-FREQUENCY LOAD CONTROL SYSTEM, and U.S. patent application Ser. No. 13/415,084 filed Mar. 8, 2012, entitled MOTORIZED WINDOW TREATMENT, the entire disclosures of which are hereby incorporated by reference.

While the motorized cellular shades 420 comprise cellular shade fabrics 412, the motorized Venetian blinds 415 each comprise a plurality of horizontally-oriented slats 422 arranged between a headrail 424 and a bottom bar 426. Lift cords 428 extend from the headrail 424 to the bottom bar 426 through the slats 422. The motor drive unit 425 is located in the headrail 424 and is able to wind and unwind the lift cord 428 around lift cord spools (not shown) to raise and lower the bottom bar 426 (in a similar manner as the motor drive units 420 for the motorized cellular shades 410 raise and lower their bottom bars 416). The motor drive units 425 of the motorized Venetian blinds 415 are also operable to tilt the respective slats 424 to either block daylight or to allow daylight to enter the room. The outside surfaces of the slats 424 may be colored appropriately to optimally reflect and block the sunlight (e.g., colored silver). The mechanical structure of the motorized Venetian blinds 415 is described in greater detail in commonly-assigned U.S. patent application Ser. No. 13/233,828, filed Sep. 15, 2011, entitled MOTORIZED VENETIAN BLIND SYSTEM, the entire disclosure of which is hereby incorporated by reference.

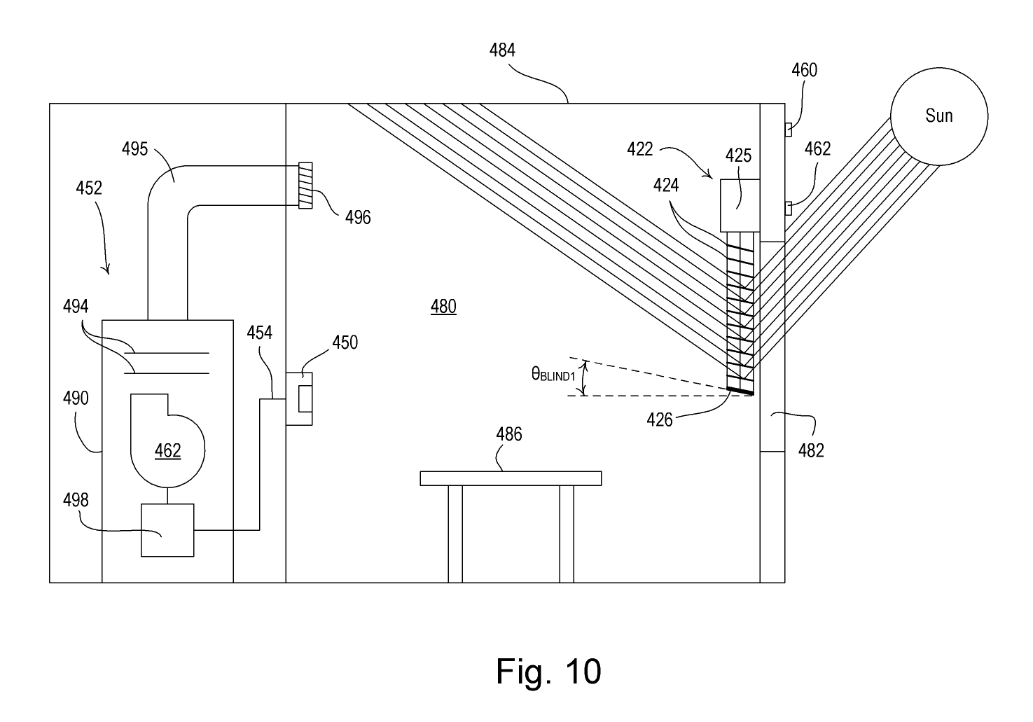

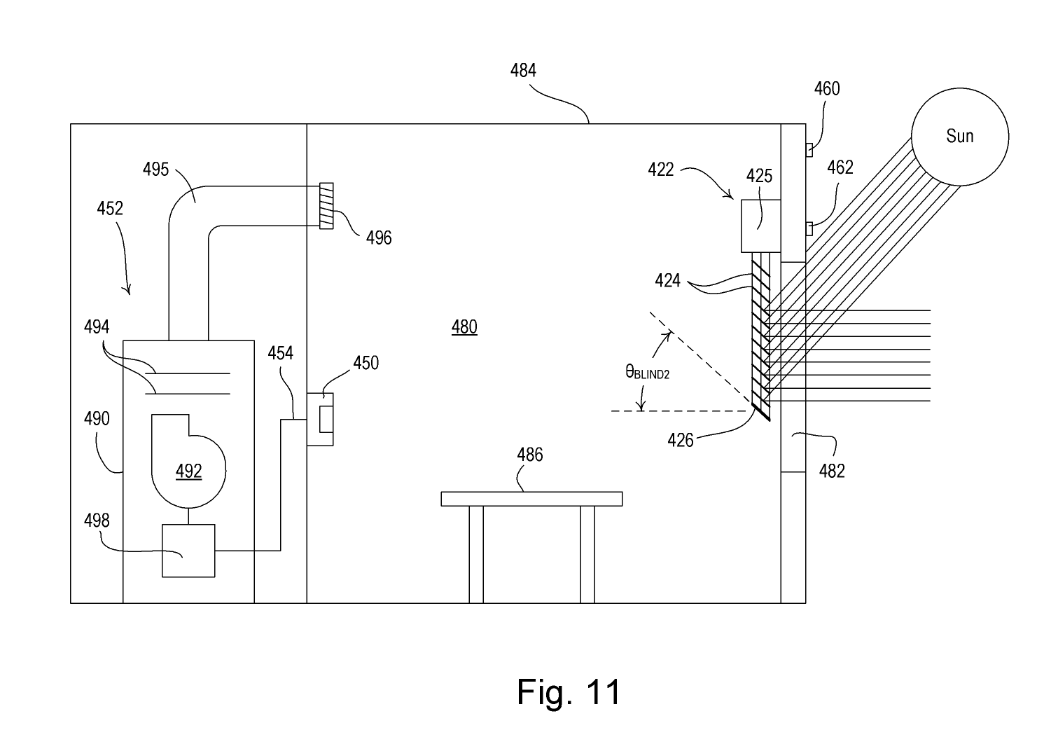

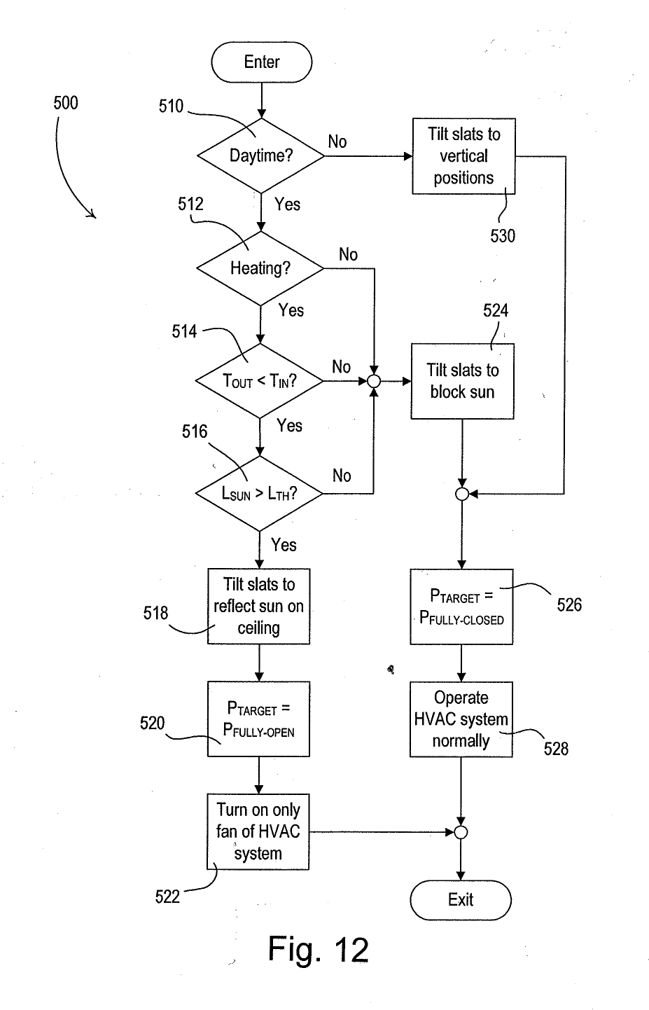

FIG. 10 is a simplified diagram of a room 480 of a building in which the motorized Venetian blinds 415 may be mounted, for example in front of a window 482. The slats 424 may be tilted by an angle θ_{BLIND1} to reflect the sunlight from the sun onto a ceiling 484 of the room 480. Accordingly, the room 480 may then be illuminated by the sunlight that is reflected onto the ceiling while avoiding direct sunlight on a work surface 486, which may be distracting to a user of the work surface. The slats 424 of the motorized Venetian blinds 415 may be rotated by an angle θ_{BLIND2} to completely block the sunlight from entering the room 480 as shown in FIG. 11. Control of the slats 424 to reflect and block sunlight is described in greater detail in commonly-assigned U.S. patent application Ser. No. 13/233,883, filed Sep. 15, 2011, entitled MOTORIZED VENETIAN BLIND SYSTEM, the entire disclosure of which is hereby incorporated by reference.

Referring back to FIG. 9, the load control system 400 further comprises a lighting control device, e.g., a wall-mountable dimmer switch 430, which is coupled to an alternating-current (AC) power source 404 via a line voltage wiring 405. The dimmer switch 430 is operable to adjust the amount of power delivered to a lighting load 432 to control the lighting intensity of the lighting load. The dimmer switch 430 is operable to transmit and receive digital messages via the RF signals 406 and is operable to adjust the lighting intensity of the lighting load 432 in response to the digital messages received via the RF signals.

The load control system 400 further comprises a wall-mounted button keypad 440 and a battery-powered tabletop button keypad 442. The wall-mounted button keypad 440 is powered from the AC power source 404 via the line voltage wiring 405, and the tabletop button keypad 442 is a battery-powered device. Both of the keypads 440, 442 transmit digital messages to the dimmer switch 430 via the RF signals 406 in order to provide for remote control of the lighting load 432. In addition, each of the keypads 440, 442 is operable to receive digital status messages via the RF signals 406 from the dimmer switch 430 in order to display the status (i.e., on/off state and/or intensity level) of the lighting load 432. The load control system 400 further comprises a battery-powered remote control 444 which is operable to transmit digital messages to the dimmer switch 430 via the RF signals 406 in order to provide for remote control of the lighting load 432. The wall-mounted button keypad 440, the tabletop button keypad 442, and the remote control 444 are also operable to adjust the present position P_{PRES} of each of the motorized window treatments 410, 415 by transmitting digital messages via the RF signals 406. In addition, the motorized window treatments 410, 415 may be operable to transmit status information to the wall-mounted keypad 440 and tabletop button keypad 442.

The load control system 400 further comprises a battery-powered wireless occupancy sensor 446 for detecting an occupancy condition (i.e., the presence of an occupant) or a vacancy condition (i.e., the absence of an occupant) in the space in which the occupancy sensor is mounted. The occupancy sensor 446 is operable to wirelessly transmit digital messages via the RF signals 406 to the dimmer switch 430 in response to detecting the occupancy condition or the vacancy condition in the space. For example, in response to detecting an occupancy condition in the space, the occupancy sensor 446 may transmit a digital message to the dimmer switch 430 to cause the dimmer switch to turn on the lighting load 432, and in response to detecting a vacancy condition in the space, transmit a digital message to the dimmer switch to cause the dimmer switch to turn off the lighting load. Alternatively, the occupancy sensor 446 could be implemented as a vacancy sensor, such that the dimmer switch 430 would only operate to turn off the lighting load 432 in response to receiving the vacant commands from the vacancy sensor. Examples of RF load control systems having occupancy and vacancy sensors are described in greater detail in commonly-assigned U.S. Pat. No. 7,940,167, issued May 10, 2011, entitled BATTERY-POWERED OCCUPANCY SENSOR; U.S. Pat. No. 8,009,042, issued Aug. 30, 2011, entitled RADIO-FREQUENCY LIGHTING CONTROL SYSTEM WITH OCCUPANCY SENSING; and U.S. patent application Ser. No. 12/371,027, filed Feb. 13, 2009, entitled METHOD AND APPARATUS FOR CONFIGURING A WIRELESS SENSOR; the entire disclosures of which are hereby incorporated by reference.

The load control system 400 further comprises a battery-powered daylight sensor 448 for measuring an ambient light intensity in the space in which the daylight sensor in mounted. The daylight sensor 448 wirelessly transmits digital messages via the RF signals 406 to the dimmer switch 430. For example, the daylight sensor 448 may transmit a digital message to the dimmer switch 430 to cause the dimmer switches to increase the intensities of the lighting load 432 if the ambient light intensity detected by the daylight sensor 448 is less than a setpoint light intensity, and to decrease the intensities of the lighting load if the ambient light intensity is greater than the setpoint light intensity. The battery-powered motorized window treatments 410 may be further operable to receive digital messages from the occupancy sensor 446 and the daylight sensor 448 via the RF signals 406 to adjust the present position of the window treatments. Examples of RF load control systems having daylight sensors are described in greater detail in commonly-assigned U.S. patent application Ser. No. 12/727,956, filed Mar. 19, 2010, entitled WIRELESS BATTERY-POWERED DAYLIGHT SENSOR, and U.S. patent application Ser. No. 12/727,923, filed Mar. 19, 2010, entitled METHOD OF CALIBRATING A DAYLIGHT SENSOR, the entire disclosures of which are hereby incorporated by reference.

The load control system 400 further comprises a battery-powered temperature control device 450 (e.g., a thermostat) that is operable to control a heating and/or cooling system, e.g., a heating, ventilation, and air conditioning (HVAC) system 452. The temperature control device 450 may be coupled to the HVAC system 452 via an HVAC communication link 454, e.g., a digital communication link (such as an RS-485 link, an Ethernet link, or a BACnet® link), or alternatively via a wireless communication link (such as an RF communication link). The temperature control device 450 may comprise an internal temperature sensor for measuring a present indoor temperature T_{IN} in the space in which the temperature control device is located. The temperature control device 450 transmits appropriate digital messages to the HVAC system 452 to control the present indoor temperature T_{IN} in the building towards a setpoint temperature. Alternatively, the HVAC communication link 454 could comprise a more traditional analog control link for simply turning the HVAC system 452 on and off. The HVAC system 452 may comprise an air handling unit 490 having a blower fan 492 for driving air (which may be cooled or heated by coils 494) through at least one duct 495 and at least one vent 496, and thus into the room 480 as shown in FIG. 10. The air handling unit 490 also comprises an HVAC controller 498 for controlling the blower fan 492 and the coils 494 to thus heat and cool the room 480. The temperature control device 450 is coupled to the HVAC controller 498 via the HVAC communication link 454 to thus control the present indoor temperature T_{IN} in the room towards the setpoint temperature.

As shown in FIG. 9, the temperature control device 450 comprises a user interface, e.g., a touch screen 456, for displaying the present indoor temperature T_{IN} and the setpoint temperature, and for receiving user inputs for adjusting the setpoint temperature. The temperature control device 450 is operable to receive RF signals 406 from a wireless temperature sensor 456 for determining the present indoor temperature T_{IN} in the space, for example, at a location away from the temperature control device 450. In addition, the motor drive units 420 of each of the motorized window treatments 410 may be operable to transmit the temperature measurements from the internal and/or external temperature sensors 160, 162 to the temperature control device 450.

In addition, the load control system 400 may further comprise an outdoor temperature sensor 460 and a sun sensor 462 that are both mounted outside the building in which the load control system is installed. The outdoor temperature sensor 460 is operable to measure the outdoor temperature T_{OUT} outside of the building and wirelessly transmit measured outdoor temperature to the control devices of the load control system 400 via the RF signals 406. The sun sensor 462 is operable to measure an intensity L_{SUN} of the sunlight shining on the building and to wirelessly transmit the measured sunlight intensity to the control devices of the load control system 400 via the RF signals 406. The load control system 400 may comprise multiple sun sensors 462 mounted on the different facades of the building to measure the intensity L_{SUN} of the sunlight shining on the different facades depending upon the location of the sun in sky. Alternatively, the sun sensor 462 could be mounted inside on the window 482 inside the room 480 to measure the intensity L_{SUN} of the sunlight shining on the window.

The load control system 400 further comprises signal repeaters 470A, 470B, which are operable to retransmit any received digital messages to ensure that all of the control devices of the load control system receive all of the RF signals 406. The load control system 400 may comprise, for example, one to five signal repeaters depending upon the physical size of the system. Each of the control devices, (e.g., the motorized window treatments 410, 415, the dimmer switch 430, the tabletop button keypad 442, the wall-mounted button keypad 440, the occupancy sensor 446, the daylight sensor 448, and the temperature control device 450) of the load control system 400 are located within the communication range of at least one of the signal repeaters 470A, 470B. The signal repeaters 470A, 470B are powered by the AC power source 404 via power supplies 472 plugged into electrical outlets 474.

According to the second embodiment of the present invention, one of the signal repeaters (e.g., signal repeater 470A) operates as a “main” repeater (i.e., a main controller) to facilitate the operation of the load control system 400. The main repeater 470A has a database, which defines the operation of the load control system, stored in memory. For example, the main repeater 470A is operable to determine which of the lighting load 432 is energized and to use the database to control any visual indicators of the dimmer switch 430 and the keypads 442, 440 accordingly to provide the appropriate feedback to the user of the load control system 400. In addition, the control devices of the load control system may be operable to transmit status information to the signal repeaters 470A, 470B. For example, the motor drive unit 420 of each of the motorized window treatments 410 may be operable to transmit a digital message representative of the magnitude of the respective battery voltage to the signal repeaters 470A, 470B, or may be operable to transmit a digital message including a low-battery indication to the signal repeaters when operating in the low-battery mode.

The main repeater is operable to operate in an eco-mode to save energy by reducing the load on the HVAC system 452. Specifically, the main repeater is operable to control the motorized window treatments 410, 415 and the temperature control devices 450 in response to the outdoor temperature T_{OUT} as measured by the outdoor temperature sensor 460, the indoor temperature T_{IN} measured by the temperature control device 450 or the wireless temperature sensor 456, and the intensities of the sunlight on the various facades of the building as measured by the sun sensors 462. The main repeater is operable to control the motorized window treatments 410, 415 to allow sunlight to enter the room 480, to turn on the blower fan 492 (while turning off the coils 494) of the HVAC system 452 on sunny winter days, such that the energy from the sunlight stores in the mass of the room. The main repeater is then operable to close the control the motorized window treatments 410, 415 to insulate the room 480 at night and allow the energy from the sunlight stored in the mass from the room to heat the room and thus reduce the load on the HVAC system 452 at night.

FIG. 12 is a simplified flowchart of an eco-mode procedure 500 executed periodically by the main repeater when the main repeater is operating in the eco-mode. The main repeater may execute the eco-mode procedure 500 multiple times (e.g., four times) to control the motorized window treatments 410, 415 on the different facades of the building. The main repeater is first operable to determine if the present time of the day is during the daytime hours at step 510 (e.g., in response to the sun sensor 462 or in response to an astronomical timeclock of the main repeater). If the present time of the day is during the daytime hours at step 510 and the HVAC system 452 is presently heating the room 480 at step 512, the main repeater determines if the outdoor temperature T_{OUT} (as measured by the outdoor temperature sensor 460) is less than the indoor temperature T_{IN} (as measured by the temperature control device 450 or the wireless temperature sensor 456) at step 514. If the outdoor temperature T_{OUT} is less than the indoor temperature T_{IN} at step 514 and the intensity L_{SUN} of the sunlight on the facade as measured by one of the sun sensors 462 is greater than a predetermined sunlight threshold L_{TH} (e.g., approximately 500 foot-candles) at step 516, the main repeater controls the motorized Venetian blinds 415 to tilt the slats 422 to reflect the sunlight onto the ceiling 484 at step 518 to thus store energy in the ceiling, for example, as shown in FIG. 10. The main repeater controls the motorized cellular shades 410 to move the bottom bar 416 to the fully-open position P_{FULLY-OPEN} at step 520. The main repeater then controls the temperature control unit 450 to turn on only the blower fan 492 of the HVAC system 452 at step 522 and the eco-mode procedure 500 exits.

If, during the daytime hours, the HVAC system 452 is presently cooling the room 480 at step 512, the outdoor temperature T_{OUT} is not less than the indoor temperature T_{IN} at step 514, or the intensity L_{SUN} of the sunlight on the facade is not greater than the predetermined sunlight threshold L_{TH} at step 516, the main repeater tilts the slats 422 of the motorized Venetian blinds 415 to block sunlight from entering the room 480 at step 524. The main repeater then controls the motorized cellular shades 410 to move the bottom bar 416 to the fully-closed position P_{FULLY-CLOSED} at step 526 and controls the HVAC system 452 to operate normally (i.e., to control the present temperature T_{IN} to the setpoint temperature) at step 528, before the eco-mode procedure 500 exits. If the present time of the day is during the nighttime hours at step 510, the main repeater tilts the slats 422 to vertical positions to insulate the room, closes the motorized cellular shades 410 at step 526, and controls the HVAC system 452 to operate normally at step 528, before the eco-mode procedure 500 exits.

Alternatively, the motorized window treatments 410, 415 could each execute eco-mode procedures to control the amount of sunlight entering the room 480 in response to the outdoor temperature sensor 460, the sun sensor 462, the temperature control device 450, and the wireless temperature sensor 456. The motorized window treatments 410, 415 could transmit digital messages via the RF signals 406 directly to the temperature control device 450 to control the blower fan 492. In addition, the motorized window treatments 410, 415 could alternatively execute the eco-mode procedures in response to the internal and external temperature sensors and the photosensor located in the motor drive units 420, 425.

While the present invention has been described with reference to the motorized cellular shades 110, 410 and the motorized Venetian blinds 415, the concepts of the present invention could be applied to other types of motorized window treatments, such as, for example, roller shades, draperies, Roman shades, Persian blinds, and tensioned roller shade systems. An example of a roller shade system is described in greater detail in commonly-assigned U.S. Pat. No. 6,983,783, issued Jan. 10, 2006, entitled MOTORIZED SHADE CONTROL SYSTEM, the entire disclosure of which is hereby incorporated by reference. An example of a drapery system is described in greater detail in commonly-assigned U.S. Pat. No. 6,994,145, issued Feb. 7, 2006, entitled MOTORIZED DRAPERY PULL SYSTEM, the entire disclosure of which is hereby incorporated by reference. An example of a Roman shade system is described in greater detail in commonly-assigned U.S. patent application Ser. No. 12/784,096, filed Mar. 20, 2010, entitled ROMAN SHADE SYSTEM, the entire disclosure of which is hereby incorporated by reference. An example of a tensioned roller shade system is described in greater detail in commonly-assigned U.S. Pat. No. 8,056,601, issued November 15, 2011, entitled SELF-CONTAINED TENSIONED ROLLER SHADE SYSTEM, the entire disclosure of which is hereby incorporated by reference.

Additional procedures for controlling motorized window treatments are described in greater detail in commonly-assigned, co-pending U.S. patent application Ser. No. 12/563,786, filed Aug. 11, 2009, entitled METHOD OF AUTOMATICALLY CONTROLLING A MOTORIZED WINDOW TREATMENT WHILE MINIMIZING OCCUPANT DISTRACTIONS, and U.S. patent application Ser. No. 12/845,016, filed Jul. 28, 2010, entitled LOAD CONTROL SYSTEM HAVING AN ENERGY SAVINGS MODE, the entire disclosures of which are hereby incorporated by reference.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A motor drive unit for a motorized window treatment having a covering material adapted to be mounted in a room next to a window, the covering material adapted to be controlled between a fully-open position and a fully-closed position to control the amount of the window covered by the covering material, the motor drive unit comprising:
a window-side temperature sensor adapted to measure an external temperature representative of the temperature outside the window; and
a controller coupled to the window-side temperature sensor for determining the external temperature representative of the temperature outside the window, the controller operable to compare the external temperature to an internal temperature to determine whether heat is flowing in or out of the room though the window, the interior temperature representative of the temperature in the room in which the window treatment is installed, the controller further operable to determine a present time of the day and year in response to a measured characteristic;
wherein the controller operates in an eco-mode to automatically control the amount of the window covered by the covering material in response to the present time of the year and whether heat is flowing in or out of the room though the window to save energy.

2. The motor drive unit of claim 1, further comprising:
a room-side interior temperature sensor adapted to measure the interior temperature;
wherein the controller is coupled to the room-side temperature sensor for determining the interior temperature.

3. The motor drive unit of claim 2, wherein the controller is operable to move the covering material to the fully-open position during the daylight hours if heat is flowing into the room through the window during the winter.

4. The motor drive unit of claim 2, wherein the controller is operable to move the covering material to the fully-closed position during the daylight hours if heat is flowing into the room through the window during the summer.

5. The motor drive unit of claim 2, wherein the controller is operable to move the covering material to the fully-closed position during the daylight hours if heat is flowing out of the room through the window during the winter.

6. The motor drive unit of claim 2, wherein the controller is operable to move the covering material to the fully-open position during the daylight hours if heat is flowing out of the room through the window during the summer.

7. The motor drive unit of claim 2, wherein the controller is operable to move the covering material to the fully-closed position during the nighttime hours.

8. The motor drive unit of claim 1, further comprising:
a sensor adapted to measure a light intensity representative of the light intensity outside the window;
wherein the controller is coupled to the room-side temperature sensor for determining the light intensity outside the window.

9. The motor drive unit of claim 8, wherein the controller is operable to move the covering material to the fully-open position during the daylight hours if heat is flowing into the room through the window and the light intensity outside the window exceeds a predetermined light threshold.

10. The motor drive unit of claim 9, wherein the controller is operable to move the covering material to the fully-closed position during the nighttime hours.

11. The motor drive unit of claim 10, wherein the predetermined light threshold comprises approximately 500 foot-candles.

12. The motor drive unit of claim 8, wherein the measured characteristic is the light intensity outside the window, the controller operable to determine the present time of day and year in response to the photosensor.

13. The motor drive unit of claim 1, wherein the window-side temperature sensor is mounted to the motor drive unit and is operable to measure the temperature between the motorized window treatment and the window.

14. The motor drive unit of claim 1, wherein the window-side temperature sensor is adapted to be mounted to an inside surface of the window for measuring the external temperature representative of the temperature outside the window.

15. The motor drive unit of claim 1, wherein the measured characteristic is the external temperature, the controller operable to determine the present time of day and year in response to the window-side temperature sensor.

16. The motor drive unit of claim 1, wherein the controller assumes that an interior temperature in the room is equal to a predetermined room temperature;
wherein the controller compares the interior temperature and the external temperature to determine whether heat is flowing in or out of the room through the window.

17. A load control system for a building comprising a window and a heating and/or cooling system, the load control system comprising:
a temperature control device adapted to be coupled to the heating and/or cooling system for controlling a present temperature in the building towards a setpoint temperature; and
a motorized window treatment for adjusting the position of a covering material between a fully-open position and a fully-closed position to control the amount of a window covered by the covering material, the motorized window treatment comprising a motor drive unit operable to determine an external temperature representative of the temperature outside the window, the motor drive unit operable to compare the external temperature to an internal temperature to determine whether heat is flowing in or out of the room though the window, the interior temperature representative of the temperature in the room in which the window treatment is installed, the motor drive unit further operable to determine a present time of the year in response to a measured characteristic;
wherein the controller operates in an eco-mode to automatically control the amount of the window covered by the covering material in response to the present time of the day and year and whether heat is flowing in or out of the room though the window, so as to reduce the power consumption of the heating and/or cooling system.

18. The load control system of claim 17, wherein the motor drive unit is operable to determine a light intensity representative of the light intensity outside the window.

19. The load control system of claim 16, wherein the controller is operable to move the covering material to the fully-open position during the daylight hours if heat is flowing into the room through the window and the light intensity outside the window exceeds a predetermined light threshold.

20. The load control system of claim 19, wherein the temperature control device is operable to turn on a fan of the heating and/or cooling system during the daylight hours if heat is flowing into the room through the window and the light intensity outside the window exceeds a predetermined light threshold.

21. The load control system of claim 20, wherein the controller is operable to move the covering material to the fully-closed position during the nighttime hours.

22. The load control system of claim 21, wherein the predetermined light threshold comprises approximately 500 foot-candles.

23. The load control system of claim 16, wherein an outside photosensor adapted to be mounted outside of the building for measuring the lighting intensity outside the window.

24. The load control system of claim 16, wherein the motor drive unit comprises a photosensor operable to measure the light intensity representative of the light intensity outside the window.

25. The load control system of claim 17, wherein the motor drive unit comprises a window-side temperature sensor operable to measure the external temperature representative of the temperature outside the window.

26. The load control system of claim 25, wherein the window-side temperature sensor is mounted to one of an enclosure of the motor drive unit or a headrail of the motorized window treatment.

27. The load control system of claim 25, wherein the window-side temperature sensor comprises a sensor label adapted to be mounted to an inside surface of the window.

28. The load control system of claim 17, further comprising:
an external temperature sensor adapted to be mounted outside the building for measuring the temperature outside the window.

29. The load control system of claim 17, wherein the measured characteristic is one of the light intensity outside the window and the external temperature.

30. The load control system of claim 17, wherein the motorized window treatment comprises a Venetian blind.

31. A method of controlling a motorized window treatment having a covering material adapted to be mounted in a room next to a window, the covering material adapted to be controlled between a fully-open position and a fully-closed position to control the amount of the window covered by the covering material, the method comprising:
measuring an external temperature representative of the temperature outside the window;
comparing the external temperature to an internal temperature to determine whether heat is flowing in or out of the room though the window, the interior temperature representative of the temperature in the room in which the window treatment is installed;
determining a present time of the year in response to a measured characteristic; and
operating in an eco-mode to automatically control the amount of the window covered by the covering material in response to the present time of the year and whether heat is flowing in or out of the room though the window to save energy.

32. The method of claim 31, further comprising:
measuring a light intensity representative of the light intensity outside the window.

33. The method of claim 32, further comprising:
moving the covering material to the fully-open position during the daylight hours if heat is flowing into the room through the window and the light intensity outside the window exceeds a predetermined light threshold.

34. The method of claim 33, further comprising:
moving the covering material to the fully-closed position during the nighttime hours.

35. The method of claim 31, further comprising:
measuring the interior temperature prior to the step of comparing.

36. The method of claim 31, further comprising:
moving the covering material to the fully-open position during the daylight hours if heat is flowing into the room through the window during the winter.
